(19) United States
(12) Patent Application Publication
(10) Pub. No.: US 2025/0171092 A1
(43) Pub. Date: May 29, 2025

(54) AERODYNAMIC SYSTEM FOR TRAILER WITH NON-PARALLEL BENDING MEMBER

(71) Applicant: Trailer Aerodynamics LLC, Chicago, IL (US)

(72) Inventors: Justin Kane MORGAN, Anderson, SC (US); Parker BAXTER, Greenville, SC (US); John SPOONER, Muskegon, MI (US)

(73) Assignee: Trailer Aerodynamics LLC, Chicago, IL (US)

(21) Appl. No.: 18/843,340

(22) PCT Filed: Feb. 24, 2023
(86) PCT No.: PCT/US2023/063223

§ 371 Date: Sep. 3, 2024

Related U.S. Application Data
(60) Provisional application No. 63/316,009, filed on Mar. 3, 2022.

(51) Int. Cl. B62D 35/00

(52) U.S. Cl. CPC B62D 35/001

(57) ABSTRACT

An apparatus is provided that has a skirt (18) with an inner surface (32), and a bending member (14) that has a vertical length. At least 30% of the vertical length of the bending member (14) does not have any surfaces parallel to the inner surface (32). The bending member (14) is longer in the vertical direction than in a lateral direction or in a longitudinal direction. The bending member (14) is configured for being deflected from an at rest position upon application of force to the skirt (18), and is configured for returning on its own to the at rest position upon the removal of the force from the skirt (18).

### CROSS-REFERENCE TO RELATED APPLICATIONS

The present application claims priority to U.S. Provisional Patent Application No. 63/316,009 filed on Mar. 3, 2022 and entitled “Aerodynamic System for Trailer with Non-Parallel Bending Member.” U.S. Provisional Application No. 63/316,009 is incorporated by reference herein in its entirety for all purposes.

### FIELD OF THE INVENTION

The subject matter of the present invention relates to an apparatus that has a bending member for use in supporting aerodynamic trailer skirts. More particularly, the present application involves a majority of a bending member that is non-parallel to the trailer skirt for increased strength and modified bending of the bending member.

### BACKGROUND OF THE INVENTION

Trailers towed by trucks and similar vehicles for transporting cargo can be large, unwieldy, and include geometries which invite inefficiencies during travel. One aspect of these inefficiencies concerns the aerodynamics of the trailer. In an effort to improve trailer aerodynamics, trailers have been built, supplemented, or retro-fitted with trailer skirts (or side skirts), devices affixed to the underside which limit air circulating in the empty space between the trailer's axles. By reducing the amount of airflow in this space, drag caused by turbulence is reduced. The reduction in drag permits the trailer to be towed more efficiently, increasing the gas mileage and performance of the vehicle and its cargo. Trailer skirts should be rigid enough to not deform in their normal operating condition to appropriately deflect air and prevent drag on the moving trailer, however the skirt needs to exhibit some degree of flexibility because it is close to the ground and can hit curbs, snow, road debris, or other objects thus necessitating movement of the skirt to prevent the skirt from being detached or damaged.

It is known to provide support members attached to the trailer that engage and support the skirt. These support members themselves can flex to accommodate flexing of the skirt when the skirt strikes an object. The support members include a bracket attached to the trailer and a bending member attached to the skirt that support the skirt in an aerodynamic position. The engagement between the bending member and the skirt is sometimes configured as a sliding arrangement such that the bending member slides along the skirt a large amount through a skirt attachment sliding bracket when the skirt is deflected outboard or inboard by a particular striking object. The bending member is made of spring steel, and once the deflection force is removed the skirt and bending member may spring back to their normal, at-rest positions. In the normal, at-rest position the bending member may have a face, the majority of which is parallel to the complimentary facing skirt face. The type of bending member is a resilient vertical bifurcating beam and can be seen in U.S. Pat. No. 10,696,335 entitled Methods and Apparatus for Pivotally Mounting Trailer Skirt, owned by the Applicant of the present application, the contents of which are incorporated by reference herein in their entirety for all purposes.

Other products in the market can be considered as either a vertical member that extends completely up and down in the vertical direction with a majority of facing surface parallel to the skirt inner surface, or a strut which is angled to the skirt panel. These designs function to support the skirt, but can be bulky, tedious to install, and require multiple components. There have been documented cases of failure where the bracket ripped off from the fasteners and rendered the system nonfunctional in addition to causing damage to the components involved. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an aerodynamic trailer system attached to a trailer with a portion of the skirt shown in hidden lines for clarity.

FIG. 2 is a side elevation view of the apparatus including the skirt, trailer mounting bracket, and bending member.

FIG. 3 is a side view of a bending member shown bending inboard in the lateral direction.

FIG. 4 is a side view of the bending member of FIG. 3 shown bending outboard in the lateral direction.

FIG. 5 is a side view of a bending member in a normal, at rest position shown attached to a trailer skirt.

FIG. 6 is a front view of the bending member of FIG. 5

FIG. 7 is a left side view of the bending member of FIG. 5.

FIG. 8 is a right side view of the bending member of FIG. 5.

FIG. 9 is a back view of the bending member of FIG. 5.

FIG. 10 is a top view of the bending member of FIG. 5.

FIG. 11 is a bottom view of the bending member of FIG. 5.

FIG. 12 is a perspective view of the bending member of FIG. 5.

FIG. 13 is a front view of the upper portion of a bending member attached to an I-beam of a trailer.

FIG. 14 is a rear view of the upper portion of the bending member attached to an I-beam of a trailer.

FIG. 15 is a perspective view of a bending member attached to a trailer skirt.

FIG. 16 is a side view of a bending member attached to an I-beam of a trailer and to a trailer skirt.

FIG. 17 is a back perspective view of the bending member of FIG. 16.

FIG. 18 is a perspective view of a top portion of the bending member of FIG. 16 attached to an I-beam of a trailer.

FIG. 19 is a front view of FIG. 18.

FIG. 20 is a perspective view of a bottom portion of the bending member of FIG. 16.

FIG. 21 is a side view of a bending member embodiment with multiple curved portions that are not parallel to the skirt.

FIG. 22 is a side view of a bending member embodiment that has multiple curved portions that are separated from one another.

FIG. 23 is a side view of a bending member embodiment that has a V-shaped section.

The use of identical or similar reference numerals in different figures denotes identical or similar features.

### DETAILED DESCRIPTION OF THE INVENTION

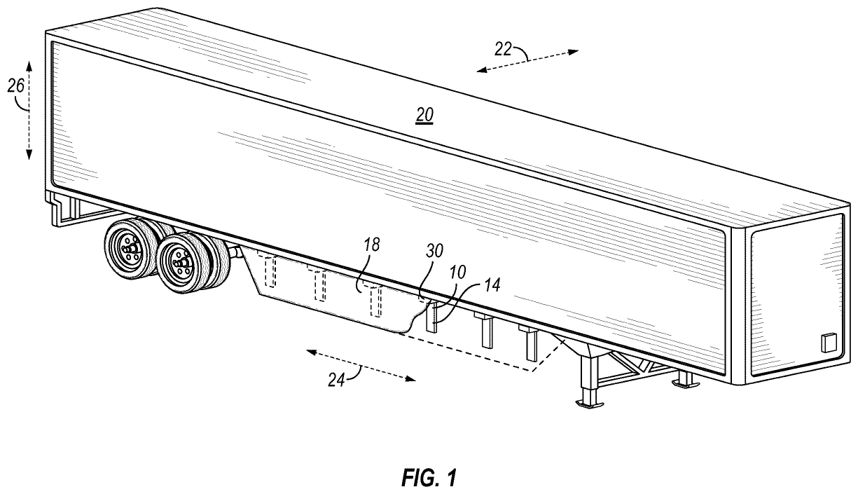

An apparatus 10 fitted onto a trailer 20 is illustrated with reference to FIG. 1 in which the skirt 18 is located under the trailer 20 and prevents air from hitting the rear wheels of the trailer 20 during travel of the trailer 20. The skirt 18 extends in a longitudinal direction 24 and may be oriented at an angle to the trailer 20 or in some instances may extend in the same direction as the length of trailer 20. The skirt 18 can have any length in the longitudinal direction 24 but generally extends from the rear wheels to the vertical support of the trailer 20. A second skirt (not shown) can be located on the opposite side of the trailer 20 to prevent or direct air flow related to the opposite side. Any number of apparatuses 10 may be used to support the skirt 18. Brackets can be attached to the top of the skirt 18 and the bottom surface or I-beams of the trailer 20 to in turn attach the skirt 18 to the trailer 20. The opposite skirt (not shown) may likewise have any number of apparatuses 10 integrated therewith for its support. The skirt 18 can be held to the trailer 20 via only the apparatuses 10, or can be held onto the trailer 20 via the apparatus 10 and additional brackets. Still further, in other embodiments the skirt 18 can be held onto the trailer 20 solely by the brackets and the apparatuses 10 can be present not to hold the skirt 18 onto the trailer 20 but to instead support the skirt 18 upon deflection and act to push it back into its normal, at-rest position.

The height of the skirt 18 may be selected so that it is large enough to cover the necessary area of air deflection that is desired, yet small enough so that it is not scraping the ground or otherwise easily hitting the road surface or objects resting on the road surface. It is presumed, however, that in the normal course of driving the skirt 18 will strike objects when the trailer 20 navigates curves, goes over objects, reaches a crown in the road, hits a snowbank, or otherwise engages anything found on roads or in distribution centers.

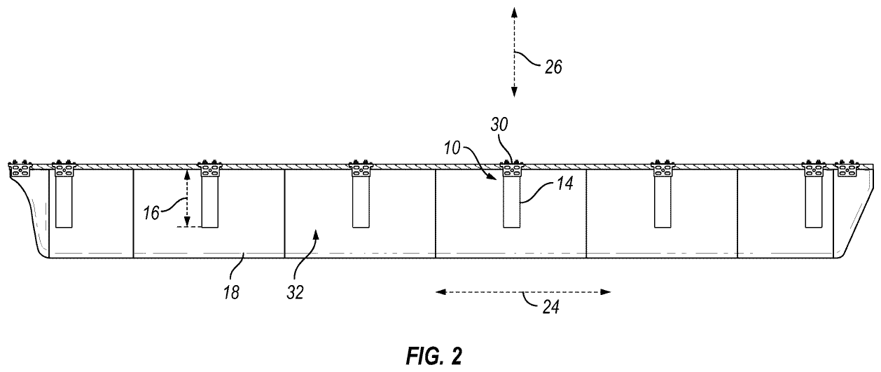

A back side view of the skirt 18 with the attached bending members 14 of the apparatus 10 is illustrated with reference to FIG. 2. An attachment device 30 is attached to the trailer 20, for example through bolting, and the bending member 14 is attached to the attachment device 30 and extends in the vertical direction 26. The bending members 14 and attachment device 30 are located at the top of the skirt 18 in the vertical direction 26 and are generally spaced evenly from one another in the longitudinal direction 24. The bending members 14 extend from the top of the skirt 18 downward in the vertical direction 26 but do not extend the entire length of the height of the skirt 18. Instead, the bending members 14 stop short of the bottom of the skirt 18. The skirt 18 may be a single piece member made up of one component or can be multiple components that are attached to one another. In the embodiment in FIG. 2, the skirt 18 is made from a plurality of central panels that are attached to one another to form almost the entire length. A rear trailer skirt panel forms the back end of the skirt 18 and is attached to the tailing central panel. The rear trailer skirt panel has a shape and size different than the central panel to which it is attached. A front trailer skirt panel is located at the front of the skirt 18 and is attached to and shaped and sized differently than the leading central panel.

The bending members 14 may be configured in a variety of manners in accordance with different exemplary embodiments so that they perform the functions of supporting the skirt 18 and allow for bending of the skirt 18 to take place when the skirt 18 engages an object so that force is applied to the skirt 18. The bending member 14 may be elongate, and can be attached to the skirt 18 using any desired mechanism, such as by use of one or more fasteners, weldments, adhesives, clamps, and/or mounting brackets as previously stated.

Reference will now be made in detail to embodiments of the invention, one or more examples of which are illustrated in the drawings. Each example is provided by way of explanation of the invention and is not meant as a limitation of the invention. For example, features illustrated or described as part of one embodiment can be used with another embodiment to yield still a third embodiment. It is intended that the present invention include these and other modifications and variations.

The apparatus 10 enables the skirts 18 to snap back into the default position once the obstacle interaction is complete by means of the bending member 14 arranged vertically 26 along the inner surface 32 of the skirt 18. The number of bending members 14 needed depends on the skirt 18 variant being used. The bending members 14 are attached to the skirt 18 and mounted on the cross I-beams 28 under the trailer 20. The bending member 14 features a shape and design that provides varying stiffness along the length of its body. The toggle location of the bending member 14 as the skirt 18 complies to the obstacle has been designed to provide the required force to bring the skirt 20 back into position.

A curved profile of the bending member 14 in some embodiments makes it unique to other products in the market that offer the same function. The bending member 14 is thus arranged so that it is not parallel to the inner surface 32, thereby making the bending member 14 neither a vertical, substantially parallel bending member nor a strut. The bending member 14 can be made stiff enough to support the skirt 18 during vehicle operating conditions for wind loads, but providing support against the tendency of the skirt 18 to flutter at certain vehicle speeds.

In some embodiments, the bending member 14 exhibits good resilience with a 3″ displacement force at the 350-400 Newton range, and a clean toggle at a force of 650-700 Newtons.

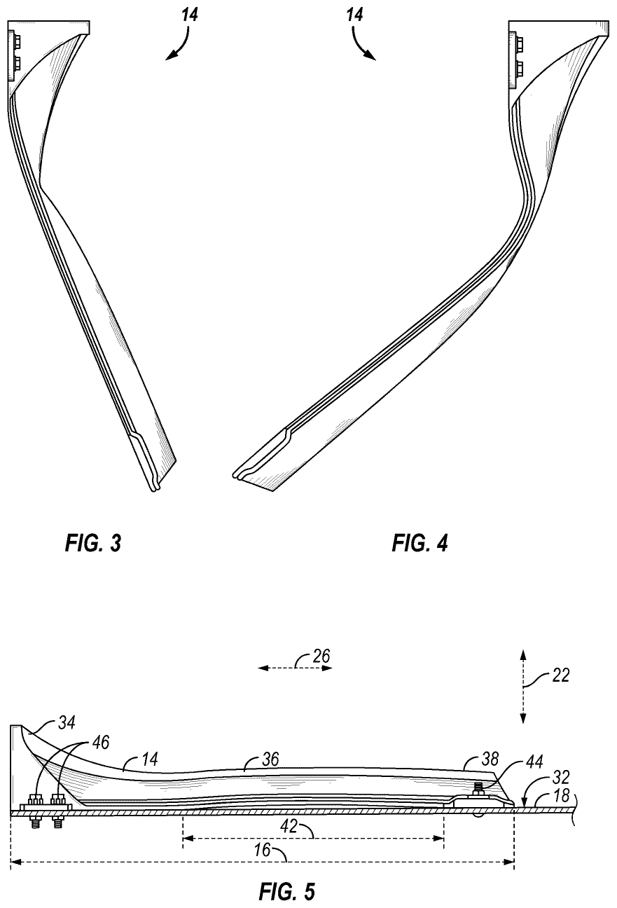

The bending member 14 can be arranged so that there is a variation in thickness along the length in the vertical direction 26 of the bending member 14. This difference in thickness allows for separate stiffness properties during inward and outward loading of the skirt 18. The bending member 14 exhibits reduced stiffness properties during outward bending of the skirt 20 as shown in FIG. 4. The bending member 14 is stiffer when bending inward in the lateral direction 22 as shown in FIG. 3. As such, the bending member 14 has different bending profiles depending upon the direction of force applied in the lateral direction 22, and different amounts of force in the lateral direction 22 are needed for similar deflections.

The bending member 14 could also be designed so that it has a cross-sectional profile in the vertical direction 26 that has a curvature of the bending member 14 at the bulbous region and a thickness variation that allows for a clean toggle in both inward and outward loading cases in the lateral direction 22.

An object of another aspect of the invention is how the moment of inertia of the bending member 14 has been tuned for stiffness, which results in a robust curved bending member 14. This tuning has resulted in increasing the longevity of the bending member 14 for bending operations by up to one hundred times.

Further, the unique non-parallel shape aides in biasing the direction of the bend under certain load cases, which Applicant theorizes is instrumental in being able to control the bending direction and toggle point of the bending member 14. The bottom of the bending member 14 in the vertical direction 26 can be attached to the skirt 18 through either a rigid connection or through a sliding connection.

A curved profile toward the bottom of the bending member 14 allows for better load distribution during bending of the skirt 18 hinging on the bending member 14 during inward loading. This reduced the stresses on the fasteners between the skirt 18 and the bending member 14, and also reduces stresses on the skirt 18. This arrangement aids in avoiding hinge cracks on the skirt 18, and inevitably improves the durability of the apparatus 10 as a whole.

The bending member 14 may in some embodiments exhibit bending resilience as a result of the profile curvature, and the variable thickness along the length of the body in the vertical direction 26, to achieve the desired moment of inertia for the bending member 14 to yield the desired performance. As stated, the bending member 14 may allow for separate bending stiffness properties for inward and outward bending cases in the lateral direction 22.

The bending member 14 can be designed in a variety of manners and need not have a single curved portion along its vertical length. For example, the curvature of the bending member 14 could be designed to include multiple curves instead of a single smooth curve as shown in some embodiments. In still other embodiments, the non-parallel arrangement could be designed to provide multiple discontinuous curves. In yet other arrangements, the non-parallel arrangement could be provided as a V-shaped profile, or could be provided as an S-shaped curve. The bending member 14 may thus be any non-parallel shape to the inner surface 32.

FIG. 5 shows the bending member 14 attached to the trailer skirt 18. The bending member 14 is provided so that the majority of its surfaces are not parallel to the inner surface 32 when the apparatus 10 is in the normal, at rest position and not experiencing deflection in the lateral direction 22. In this regard, some of the surfaces of the bending member 14 may in fact be parallel to the inner surface 32, but the majority are not. This determination is made by making measurements of the surface area of the entire bending member 14 and determining how much of this surface area is parallel to the inner surface 32, and how much of this measured surface area of the bending member 14 is not parallel to the inner surface 32. In other embodiments, the non-parallel characteristic of the bending member 14 is assigned based upon only the surface area of the bending member 14 directly facing the inner surface 32. The portion of the bending member 14 facing inboard in the lateral direction 22 need not be used in the calculation. For the most part, however, these areas will be the same or very close to one another. The bending member 14 is thus arranged so that a minority of its surface area is parallel to the inner surface 32.

Another way to express the non-parallel feature of the bending member 14 is to express it in terms of the vertical length 16 of the bending member 14. The vertical length 16 is the length of the bending member 14 in the vertical direction 26 during the normal, at rest position with no deflection of skirt 18. The bending member 14 is non-parallel in that at least 30% of the vertical length 16 does not have any surface area that is parallel to the inner surface 32. Some of the vertical length 16 may have some surface area that is parallel to the inner surface 32, but at least 30% of the vertical length 16 is oriented at a non-parallel position to the inner surface 32. In other embodiments, at least 50% of the vertical length 16 does not have any surface area that is parallel to the inner surface 32. In other embodiments, at least 90%, at least 80%, at least 70%, at least 60%, or at least 40% of the vertical length 16 is oriented at a non-parallel position to the inner surface 32 such that it has no surface that is parallel to the inner surface 32. These various percentages can be calculated as a percentage of the total vertical length 16, and the length of the bending member 14 having no parallel surfaces to the inner surface 32 can be a continuous length that makes up the percentage, or can be two or more sections of length that when added together make up the percentage.

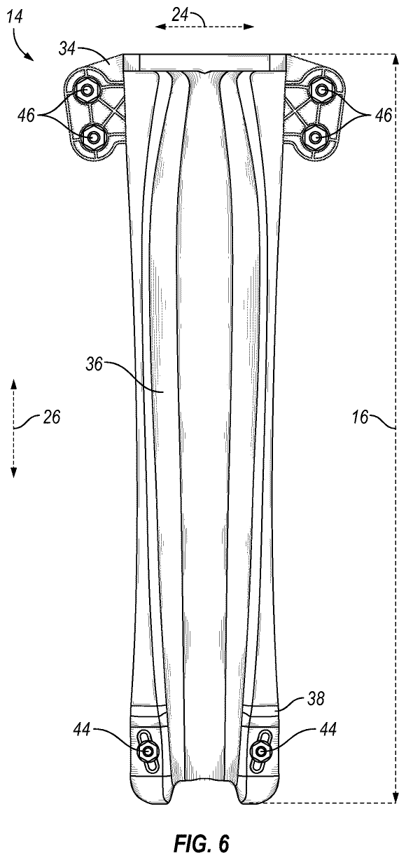

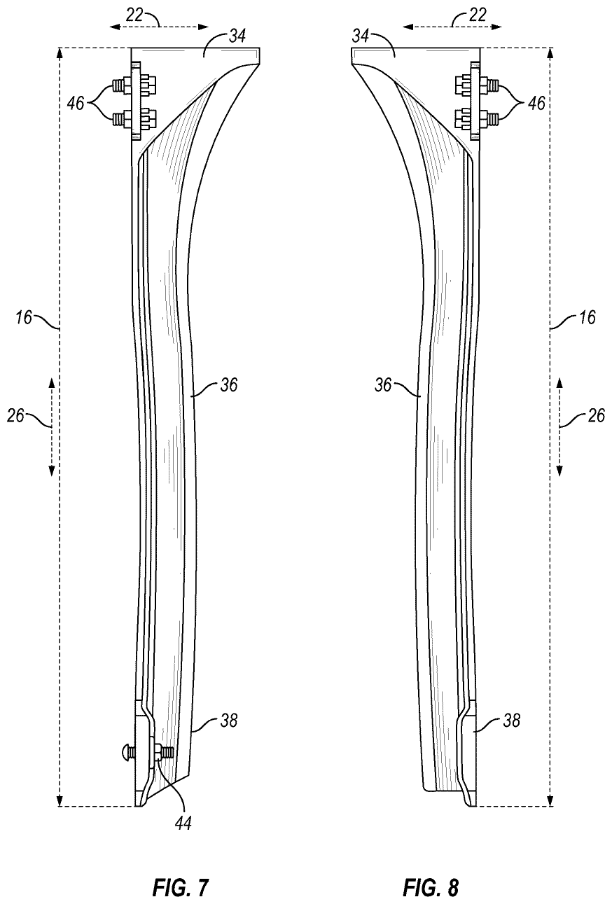

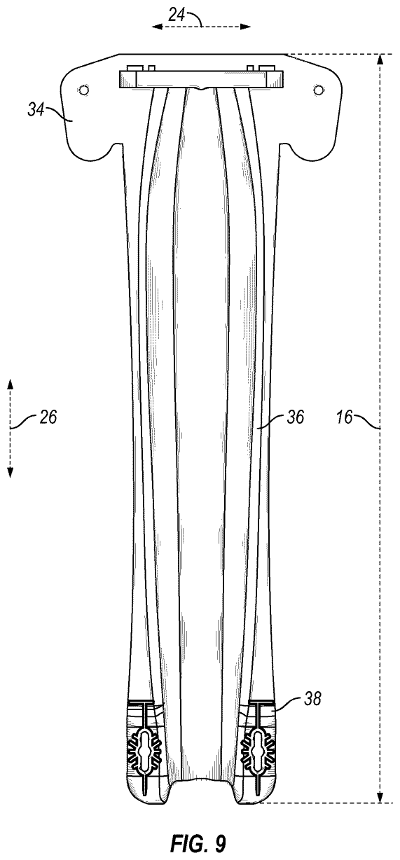

The bending member 14 has a top portion 34 that is wider in the longitudinal direction 24 than the rest of the bending member 14, and has apertures that receive bolts 46 for attachment to the upper side of the skirt 18. The front view in FIG. 6 shows the top portion 34 with a pair of ears at its ends in the longitudinal direction 24 that receive bolts 46 for the aforementioned attachment. The top portion extends for a longer distance in the lateral direction 22 than the other portions of the bending member 14 as shown in FIG. 7. The middle portion 36 extends in the vertical direction 26 from the top portion 34 and has a longer length in the vertical direction 26 than does the top portion 34. The entire percentage of the bending member 14 that does not have any surfaces planar to the inner surface 32 may be completely within the middle portion 36. In some embodiments, the middle portion 36 does not have any surface that is parallel to inner surface 32. At the bottom of the middle portion 36 in the vertical direction 26 is the bottom portion 38. The bottom portion 38 may have some surface area that is parallel to the inner surface 32, and some of the length of the bottom portion 38 in the vertical direction 26 can have one or more surfaces parallel with the inner surface 32.

With reference to FIG. 5, the bottom portion 38 has slots that receive bolts or other members 44 that are in turn rigidly attached to the skirt 18. During bending of the bending member 14, the slots in the bottom portion 38 allow these bolts or members 44 to slide relative to the bending member 14, but the bolts or members 44 are still captured by the bottom portion 38 to prevent detachment. In other embodiments, the bottom portion 38 is bolted to the skirt 18 without the slots or any sliding functionality, and in other embodiments the bottom portion 38 is not bolted to the skirt 18 but slides via a sliding member with the skirt, as shown the patent incorporated herein and previously discussed. Any type of attachment, or no attachment, may be made between the bottom portion 38 and the skirt 18. The middle portion 36 may or may not be attached to the skirt 18.

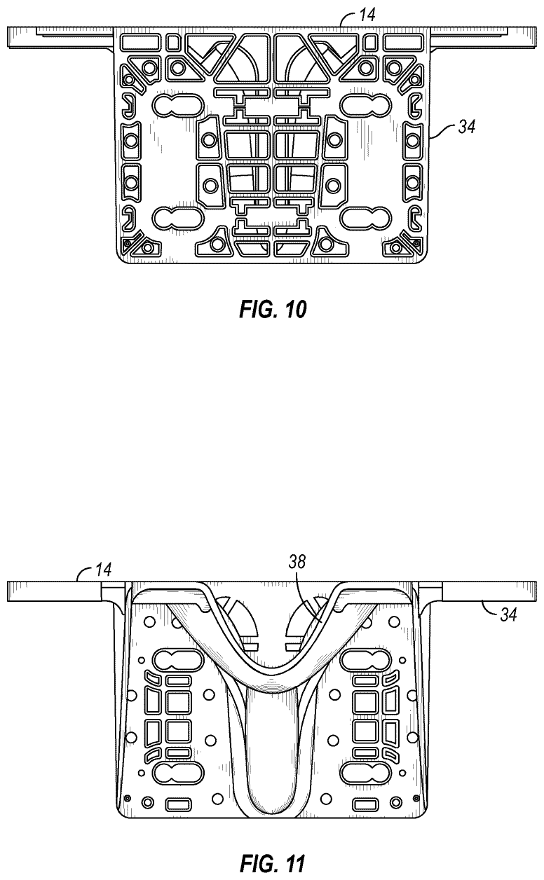

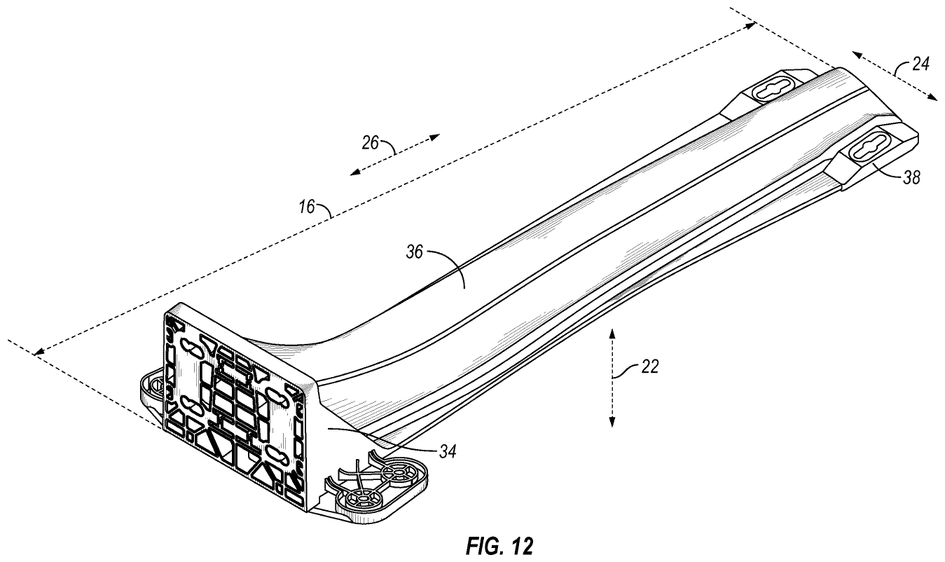

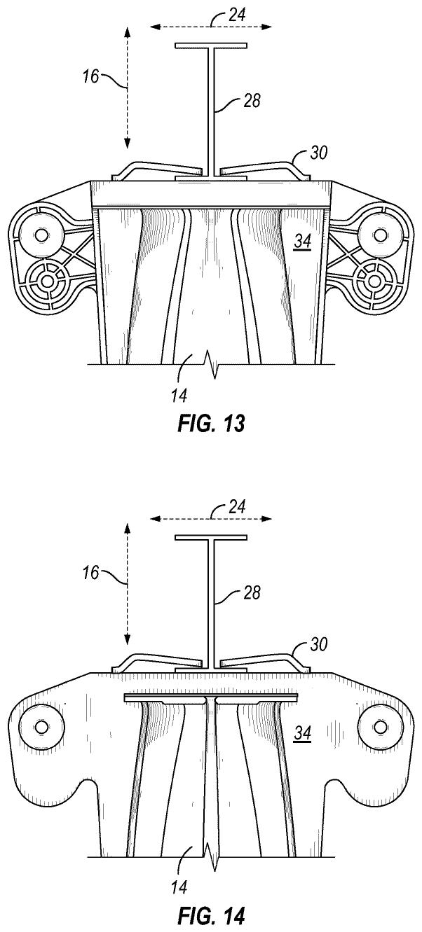

FIGS. 10 and 11 show the top and bottom views of the bending member 14. The top portion 34 has apertures through which bolts can be inserted for attachment to I-beams 28 or other portions of the trailer 20. The cross-sectional shape of the majority of the bending member, especially in the middle portion 36 is curved/C-shaped such that a large amount of the area of the middle portion 36 and the bending member 14 overall includes surface area that is not parallel to the inner surface 32. FIGS. 13 and 14 show one possible attachment configuration of the bending member 14 to the trailer 20. An attachment device 30 engages both the top portion 34 and the bottom flange of the I-beam 28. Bolts can be inserted through the apertures of the top portion 34 and through the attachment device 30 to fix the attachment device 30 to the top portion 34. Tightening of the bolts causes the attachment device 30 to clamp down onto the bottom flange of the I-beam 28 to cause the bending member 14 to be secured to the I-beam 28. The bolts that tighten the attachment device 30 may or may not engage the I-beam 28. The disclosed attachment arrangement is only exemplary, and other various types of attachment of the bending member 14 to the I-beam 28 or other part of the trailer 20 can be used in other embodiments.

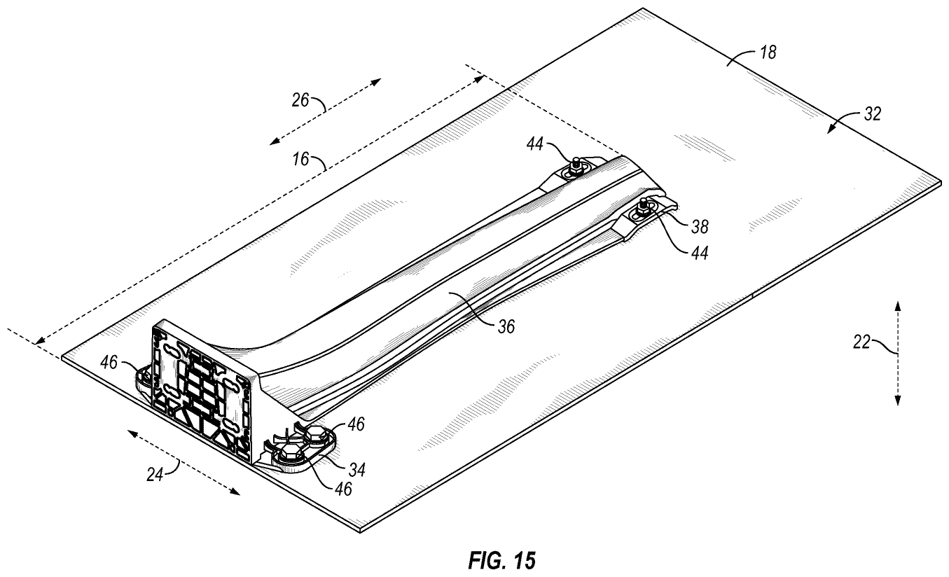

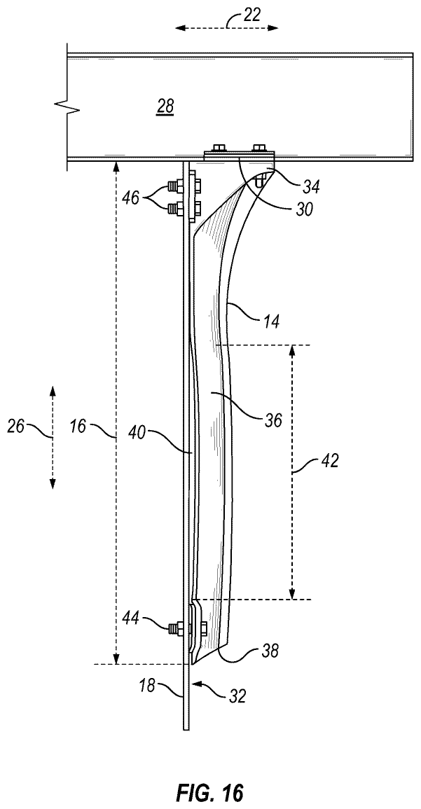

FIGS. 15 and 16 show the bending member 14 attached to the skirt 18 and a space 40 is defined between the inner surface 32 and the bending member 14, specifically at a non-parallel section 42 of the bending member 14. The non-parallel section 42 is a length of the bending member 14 that does not have any surface area that is parallel to the inner surface 32. The length of the non-parallel section 42 can be any one of the percentages of the vertical length 16 as previously discussed. Although a single non-parallel section 42 is shown, other sections of the bending member 14 may likewise have no surfaces that are parallel to inner surface 32. The bending member 14 is arranged so that it has a single curved section 42, and flat/parallel portions in the top portion 34 and the bottom portion 38.

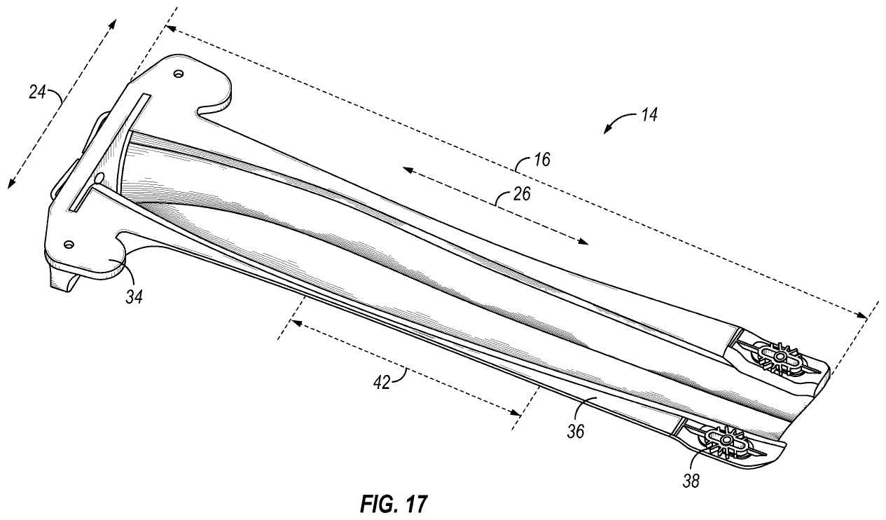

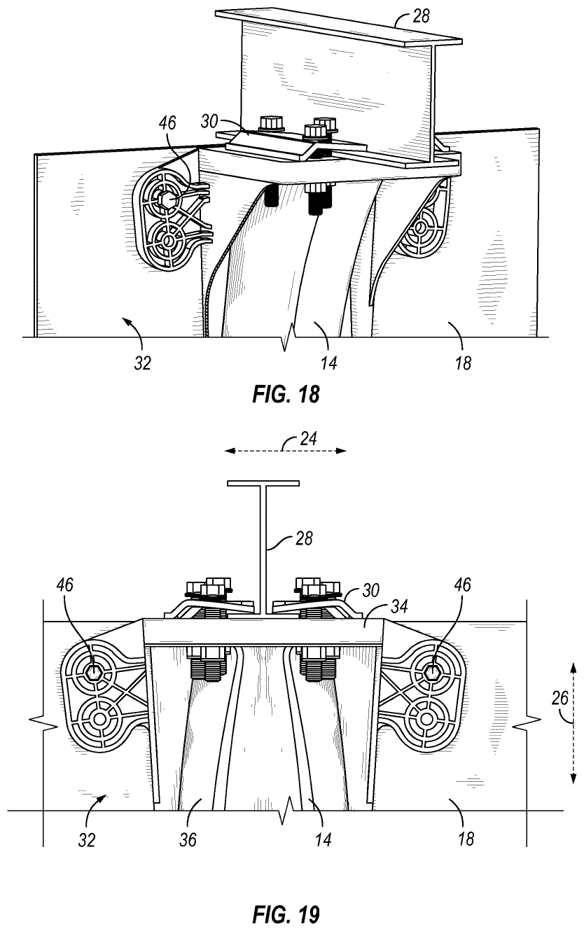

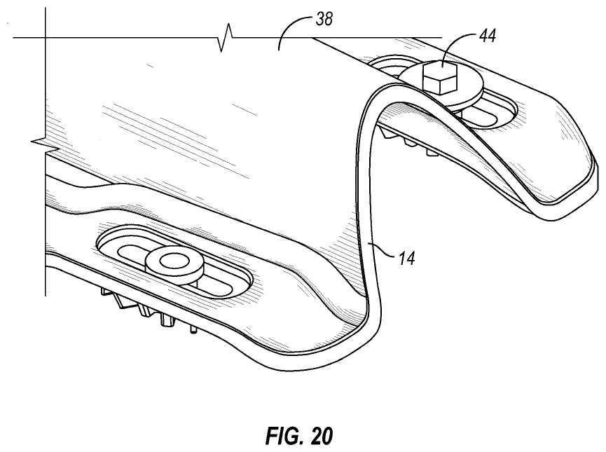

With reference now to FIGS. 17-20, the attachment device 30 may be seen to have multiple bolts that cause attachment of the bending member 14 to the I-beam 28. The top portion 34 is also shown attached to the skirt 18, and the bending member 14 engages the inner surface 32. The bolts that tighten the attachment device 30 do not engage the I-beam 28. The bottom portion 38 has some planar surfaces that are parallel to the inner surface 32. The portion of the bottom portion 38 that defines the slots into which the bolts or members 44 in the skirt 18 may ride have planar portions that are parallel to the inner surface 32. These planar portions are on both sides of the bottom portion 38 in the lateral direction 22, both those directly facing the inner surface 32 and those facing directly away from the inner surface 32. In other embodiments, the portions of the bottom portion 38 that define the slots can be curved in their entirety such that no portion of the bottom portion 38 has a surface that is parallel to the inner surface 32.

Although the bottom portion 38 is shown as having some surfaces that are parallel to the inner surface 32, in other embodiments the bending member 14 can be arranged so that no portion of the bottom portion 38 has a surface parallel to the inner surface 32. In addition, no surface area of the middle portion 36 may be parallel to the inner surface 32 in some embodiments, and in these instances the only section of the bending member 14 that has any surface parallel to the inner surface 32 is in the top portion 34.

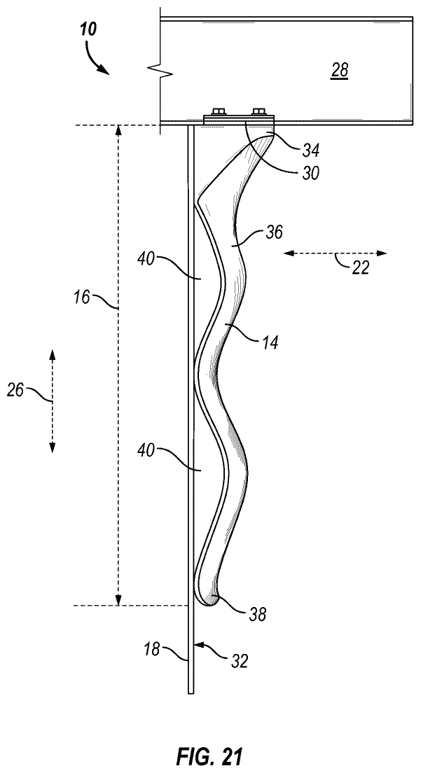

Yet further embodiments of the apparatus 10 are possible. FIG. 21 is a side view of another embodiment of apparatus 10 in which the bending member 14 has multiple curved sections. As shown, the bending member 14 is curved such that two concave surfaces directly face the inner surface 32, and at least one convex surface directly faces the inner surface 32. However, none of these surfaces are parallel to the inner surface 32 as they are all curved. The two curved sections of the bending member 14 directly engage one another and are in the middle portion 36. The sides of the bending member 14 that don't directly face the inner surface 32 are arranged as two convex shapes and one concave shape.

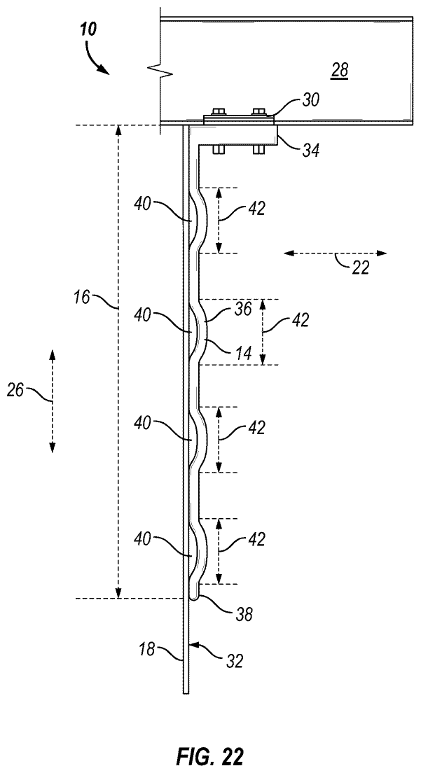

FIG. 22 is another exemplary embodiment of the apparatus 10 in which the bending member 14 is configured differently than in other embodiments. Here, the bending member 14 has multiple non-parallel sections 42 that are discontinuous from one another. In this regard, portions of the bending member 14 that have parallel surfaces are positioned between successive ones of the non-parallel sections 42 that have no surfaces parallel to the inner surface 32. There are four non-parallel sections 42 that are spaced from one another, but the bending member 14 could include any number in other embodiments. The non-parallel sections 42 have concave surfaces that directly face the inner surface 32, and convex surfaces that face away from the inner surface 32. The total percentage of the bending member 16 that has no parallel surface to inner surface 32 can be found by adding up the length of all the non-parallel sections 42 in the vertical direction 26 and then dividing by the vertical length 16. Although all of the non-parallel sections 42 are oriented in the same manner, in other arrangements the convex surfaces of the non-parallel sections 42 may directly face the inner surface 32.

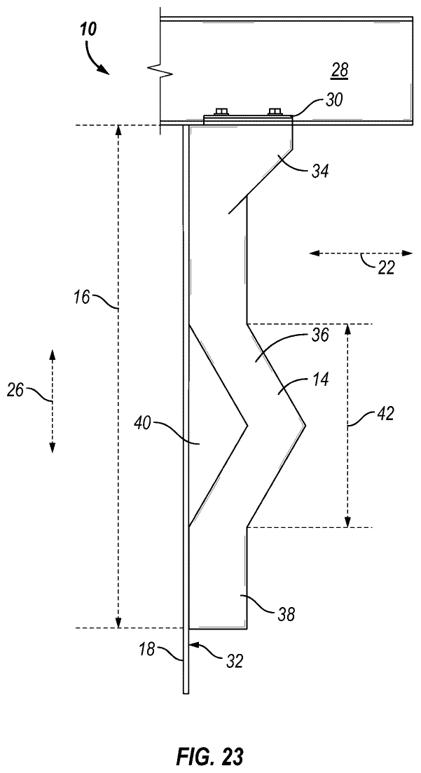

FIG. 23 shows an embodiment of the bending member 14 in which it has a V-shaped section that includes surfaces that are not parallel to inner surface 32. The bottom portion 38 has surfaces parallel to the inner surface 32, and engages and is attached to the inner surface 32. The V-shaped portion is the non-parallel section 42 of the bending member 14 and is in the middle portion 36, with part of the middle portion 36 having a surface parallel to the inner surface 32. The space 40 is located between the inner surface 32 and V-shaped section such that the V-shaped section does not touch the inner surface 32. The bending member 14 may be U shaped in other embodiments. It is to be understood that the disclosed shapes of the bending member 14 are only exemplary and that multiple shapes are possible in accordance with other exemplary embodiments.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1-14. (canceled)

15. An apparatus, comprising:
a skirt that has an inner surface; and
a bending member that has a vertical length in a vertical direction, wherein surfaces facing the inner surface along at least 30% of the vertical length of the bending member are non-parallel to the inner surface;
wherein the bending member is longer in the vertical direction than in a lateral direction, and wherein the bending member is longer in the vertical direction than in a longitudinal direction; and
wherein the bending member is configured for being deflected from an at rest position upon application of force to the skirt, and wherein the bending member is configured for returning on its own to the at rest position upon removal of the force from the skirt.

16. The apparatus as set forth in claim 15, wherein the at least 30% of the vertical length of the bending member is a non-parallel section that is a continuous section in the vertical direction.

17. The apparatus as set forth in claim 16, wherein the non-parallel section has a single continuous concave surface that directly faces the inner surface along an entire height of the non-parallel section in the vertical direction.

18. The apparatus as set forth in claim 15, wherein surfaces facing the inner surface along at least 50% of the vertical length of the bending member are non-parallel to the inner surface.

19. The apparatus as set forth in claim 18, wherein surfaces facing the inner surface along at least 70% of the vertical length of the bending member are non-parallel to the inner surface.

20. The apparatus as set forth in claim 19, wherein surfaces facing the inner surface along at least 80% of the vertical length of the bending member are non-parallel to the inner surface.

21. The apparatus as set forth in claim 15, further comprising an attachment device configured to attach the bending member to an I-beam of a trailer.

22. The apparatus as set forth in claim 15, wherein the bending member has a top portion, a middle portion, and a bottom portion, wherein the top portion is located higher in the vertical direction than the middle portion and the bottom portion, and wherein the middle portion is located between the top portion and the bottom portion in the vertical direction; and
wherein surfaces of the middle portion that face the inner surface are non-parallel to the inner surface, and wherein a space is defined between the inner surface and the middle portion in the lateral direction.

23. The apparatus as set forth in claim 15, wherein the bending member defines a slot and is attached to the skirt by a fastener that is disposed through the slot, and wherein the fastener moves along the slot during bending of the bending member and the skirt.

24. The apparatus as set forth in claim 23, wherein a part of the bending member that defines the slot has planar portions that are parallel to the inner surface.

25. The apparatus as set forth in claim 15, wherein the least 30% of the vertical length of the bending member that does not have any surfaces parallel to the inner surface is a non-parallel section that has a convex part that directly faces the inner surface, and that has two concave parts that directly face the inner surface.

26. The apparatus as set forth in claim 15, wherein the at least 30% of the vertical length of the bending member is a non-parallel section that is not continuous in the vertical direction such that discontinuities are created by parallel sections of the bending member that have surfaces parallel to the inner surface.

27. The apparatus as set forth in claim 15, wherein the at least 30% of the vertical length of the bending member is spaced from the inner surface.

28. The apparatus as set forth in claim 15, wherein a majority of a total surface area of the bending member is non-parallel to the inner surface.
